(19) United States
(12) Patent Application Publication
(10) Pub. No.: US 2012/0103937 A1
(43) Pub. Date: May 3, 2012

(54) METHOD OF MANUFACTURING GLASS SUBSTRATE FOR MAGNETIC STORAGE MEDIUM

(75) Inventor: Kazuyuki HANEDA, Ichihara-shi (JP)

(73) Assignee: SHOWA DENKO K.K., Tokyo (JP)

(21) Appl. No.: 13/278,531

(22) Filed: Oct. 21, 2011

(30) Foreign Application Priority Data
Oct. 29, 2010 (JP) 2010-244051

(51) Int. Cl. G11B 5/84; B44C 1/22

(52) U.S. Cl. 216/53; 216/52

(57) ABSTRACT

A method of manufacturing a glass substrate for a magnetic recording medium, wherein inner and outer circumference end faces of a disk-like glass substrate having a central aperture are at least treated by: a step of grinding, a step of etching, and a step of polishing, wherein the steps are performed in this order.

### TECHNICAL FIELD

The present invention relates to a method of manufacturing a glass substrate for a magnetic storage medium.

Priority is claimed on Japanese Patent Application No. 2010-244051, filed Oct. 29, 2010, the content of which is incorporated herein by reference.

### BACKGROUND ART

The recording density of a magnetic storage medium used for a hard disk drive (HDD) has remarkably increased. The increase in the surface recording density has particularly become more dramatic since a magnetoresistive (MR) head and PRML techniques were introduced. In recent years, a GMR head, a TMR head and the like have also been introduced, and the surface recording density continues to increase at a pace of approximately 1.5 times per year. There are strong demands for achieving even higher recording density hereafter.

Furthermore, due to such an increase in the recording density of magnetic recording media, demands for a substrate which is used for a magnetic recording medium have also increased. As a substrate for a magnetic recording medium, an aluminum alloy substrate and a glass substrate have conventionally been used. Among the substrates, a glass substrate is superior to an aluminum alloy substrate with respect to hardness, surface smoothness, rigidity and impact resistance thereof. Therefore, attention has been focused on a glass substrate for a magnetic recording medium, wherein the substrate enables a higher recording density to be achieved.

When a glass substrate for a magnetic recording medium is manufactured, a disc-like glass substrate is cut out from a large tabular glass plate, or press molding is performed using a mold to directly obtain a disk-like glass substrate from a molten glass, and subsequently, lap (grinding) treatment and polish (polishing) treatment are performed for principal surfaces and an end faces of the obtained glass substrate.

Furthermore, as conventional steps for manufacturing a glass substrate for a magnetic recording medium, primary lapping (grinding), secondary lapping (grinding), a primary polishing (polishing) and a secondary polishing (polishing) are performed in this order for principal surfaces of a glass substrate. During these treatment steps, grinding and polishing are performed for end faces of inner and outer circumferences of a glass substrate.

Here, as prior art documents with respect to the present invention, for example, there are Patent documents 1 and 2 shown below. Specifically, Patent document 1 discloses a method of manufacturing a glass substrate which includes; grinding of inner and outer circumference end faces with an abrasive wheel; chamfering of inner and outer circumference edge portions; and polishing of inner and outer circumferences with slurry including cerium oxide abrasive grains as polishing grains (free abrasive grains).

On the other hand, Patent document 2 discloses a method of manufacturing a glass substrate used for a magnetic disk, wherein the method includes in this order, a step of grinding inner and outer circumference end faces wherein end faces of inter and outer circumferences of a doughnut-like glass block are grinded; a step of etching the grinded inner and outer circumference end faces of the doughnut-like glass block; a separation and cleaning step wherein the etched doughnut-like glass block is separated into doughnut-like glass substrates, and the separated doughnut-like glass substrates are cleaned; a step of chamfering edge portions of the outer and inner circumferences of the cleaned doughnut-like glass substrates; and a step of polishing the inner and outer circumference end faces and the chamfered portions of the chamfered doughnut-like glass substrates.

### PRIOR ART DOCUMENTS

### Patent Documents

Patent document 1: Japanese Unexamined Patent Application, First Publication No. 2010-30807
Patent document 2: Japanese Unexamined Patent Application, First Publication No. 2010-3365

### DISCLOSURE OF INVENTION

### Problem to be solved by the Invention

Here, in order to achieve even higher recording density of HDD as described above, it is necessary to increase the number of a magnetic recording medium provided in a limited space of the HDD. It is conceivable that a glass substrate for a magnetic storage medium is made thin in order to increase said number, but it is necessary for such a glass substrate for a magnetic storage medium to have impact strength which is more than or equal to the impact strength of conventional glass substrates.

Accordingly, in order to remove cracks which are generated at chamfer faces or inner and outer circumference end faces of a glass substrate and are a large factor in reducing impact strength, chemical-mechanical polishing (CMP), wherein cerium oxide is used, is performed as an essential step in general in a method of manufacturing a glass substrate for a magnetic recording medium.

However, in recent years, it has been difficult to obtain cerium oxide, which is an essential used in the polishing step of a glass substrate for a magnetic recording medium. Therefore, there is a demand for achieving a method of manufacturing a glass substrate for a magnetic recording medium, wherein a glass substrate having impact strength similar to that of conventional glass substrates can be generated, even if cerium oxide is not used or the amount of cerium oxide is reduced in a polishing step of a glass substrate for a magnetic recording medium. Furthermore, it is desired that such a glass substrate for a magnetic recording medium can be generated at high productivity.

The present invention is proposed based on such a conventional circumstance, and a purpose of the present invention is provide a method of manufacturing a glass substrate for a magnetic recording medium, wherein a glass substrate having sufficient impact strength is generated at high productivity while cerium oxide is not used or the amount of cerium oxide is reduced in a polishing step.

### Means for Solving the Problem

The present invention provides the following methods.

(1) A method of manufacturing a glass substrate for a magnetic recording medium, wherein inner and outer circumference end faces of a disk-like glass substrate having a central aperture are at least treated by:

a step of grinding,

a step of etching, and

a step of polishing, wherein

the steps are performed in this order.

(2) The method of manufacturing a glass substrate for a magnetic recording medium described in the aforementioned (1), wherein silicon oxide is used as an abrasive in the aforementioned polishing.

(3) The method of manufacturing a glass substrate for a magnetic recording medium described in the aforementioned (1) or (2), wherein an average particle diameter of the silicon oxide is more than or equal to 0.4 μm and less than or equal to 1 μm.

(4) The method of manufacturing a glass substrate for a magnetic recording medium described in any of the aforementioned (1) to (3), wherein a hydrofluoric acid is used in the etching.

(5) The method of manufacturing a glass substrate for a magnetic recording medium described in any of the aforementioned (1) to (4), wherein cerium oxide is not used as an abrasive in the polishing.

### Effects of Invention

As described above, the present invention performs an etching step between a grinding step and a polishing step, and therefore, it is possible to manufacture a glass substrate for a magnetic recording medium, which achieves sufficient impact resistance, at high productivity, even if a reduced amount of cerium oxide is used or cerium oxide is not used at the time of polishing treatment.

### BRIEF DESCRIPTION OF THE DRAWINGS

FIG. 1 is a perspective view which is used to explain a manufacturing step of a glass substrate for a magnetic recording medium according to the present invention, and shows a lapping step for principal surfaces.

FIG. 2A is a plane view wherein a pad surface of a diamond pad which is used in a lapping step for principal surfaces is enlarged.

FIG. 2B is a plane view wherein a pad surface of a diamond pad which is used in a lapping step for principal surfaces is enlarged.

FIG. 3 is a perspective view which is used to explain a manufacturing step of a glass substrate for a magnetic recording medium according to the present invention and shows a grinding step for inner and outer circumference end faces.

FIG. 4 is a perspective view which is used to explain a manufacturing step of a glass substrate for a magnetic recording medium according to the present invention and shows a polishing step for an inner circumference end face.

FIG. 5 is a perspective view which is used to explain a manufacturing step of a glass substrate for a magnetic recording medium according to the present invention and shows a polishing step for an outer circumference end face.

FIG. 6 is a perspective view which is used to explain a manufacturing step of a glass substrate for a magnetic recording medium according to the present invention and shows a polishing step for principal surfaces.

FIG. 7 is a perspective view which is used to explain a manufacturing step of a glass substrate for a magnetic recording medium according to the present invention and shows primary and secondary grinding steps for inner and outer circumference end faces.

FIG. 8 is a perspective view which shows another structural example of a lapping machine or polishing machine used in the present invention.

### BEST MODE FOR CARRYING OUT THE INVENTION

Hereinafter, a method of manufacturing a glass substrate for a magnetic recording medium, to which the present invention is applied, is explained in detail while referring to Figures.

A glass substrate for a magnetic recording medium, which is manufactured according to the present invention, is a disk-like glass substrate having a central aperture. A magnetic recording medium has a structure, wherein a magnetic layer, a protecting layer, a lubricating layer and the like are laminated in this order on the aforementioned glass substrate. Furthermore, in a magnetic recording and regenerating device (HDD), the center of the magnetic recording medium is attached to a rotating shaft of a spindle motor, and recording and regeneration of information are performed to the magnetic recording medium, while a magnetic head moves above the surface of the magnetic recording medium which is rotationally driven by the spindle motor.

Here, as a glass substrate for a magnetic recording medium, for example, SiO₂—Al₂O₃—R₂O (R represents at least one kind selected from alkali metal elements) -based chemically strengthened glasses, SiO₂—Al₂O₃—Li₂O-based glass ceramics, SiO₂—Al₂O₃—MgO—TiO₂-based glass ceramics and the like can be used.

Among them, SiO₂—Al₂O₃—MgO—CaO—Li₂O—Na₂O—ZrO₂—Y₂O₃—TiO₂—As₂O₃-based chemically strengthened glass, SiO₂—Al₂O₃—Li₂O—Na₂O—ZrO₂—As₂O₃-based chemically strengthened glass, SiO₂—Al₂O₃—MgO—ZnO—Li₂O—P₂O₅—ZrO₂—K₂O—Sb₂O₃-based glass ceramics, SiO₂—Al₂O₃—MgO—CaO—BaO—TiO₂—P₂O₅—As₂O₃-based glass ceramics, SiO₂—Al₂O₃—MgO—CaO—SrO—BaO—TiO₂—ZrO₂—Bi₂O₃—Sb₂O₃-based glass ceramics and the like are suitably used. Furthermore, for example, glass ceramics are suitable as a glass substrate for a magnetic recording medium, wherein the glass ceramics include, as a crystal phase, lithium disilicate, SiO₂-based crystal (quartz, cristobalite, tridymite or the like), cordierite, enstatite, aluminum magnesium titanate, spinel type crystal ([Mg and/or Zn]Al₂O₄, [Mg and/or Zn]₂TiO₄, and a solid solution between said two crystals), forsterite, spodumene, a solid solution of the crystals, or the like.

Furthermore, when a glass substrate of a magnetic recording medium is manufactured, at first, a disk-like glass substrate having a central aperture is produced by cutting out a glass substrate from a large tabular glass plate or by performing direct press molding using a mold to obtain a glass substrate from molten glass.

Subsequently, lapping (grinding) and polishing (polishing) are performed with respect to surfaces (principal surfaces) of the obtained glass substrate except for end faces thereof. Furthermore, between the steps, a grinding step, an etching step and polishing step are performed for the end faces of outer and inner circumferences of the glass substrate. In the present invention, chamfering, which is performed for outer and inner circumference end faces of the glass substrate, may be performed when the aforementioned grinding is performed, so that they are performed in the same step. Furthermore, grinding which is performed for the outer and inner circumference end faces of the glass substrate may be performed not only in one step, but also in two steps (primary grinding and secondary grinding).

In the method of manufacturing a glass substrate for a magnetic recording medium according to the present invention, it is possible to grind outer and inner circumference end faces of a glass substrate simultaneously, using an outer circumference grinding wheel and an inner circumference grinding wheel, wherein diamond abrasive grains are included. Micro-cracks which may be generated at the time of the aforementioned grinding are eliminated by etching which is subsequently performed. Due to such etching, a glass substrate for a magnetic recording medium can be obtained which has impact resistance similar to that of conventional glass substrates after polishing is finally performed for outer and inner circumference end faces of the glass substrate, even if merely mechanical polishing is performed.

In conventional methods of manufacturing a glass substrate for a magnetic recording medium, chemical-mechanical polishing (CMP) using cerium oxide slurry is used when polishing is performed for inner and outer circumference end faces of a glass substrate. In the polishing, if treatment using cerium oxide slurry is changed to treatment using silicon oxide slurry, chemical polishing effects achieved by CMP become insufficient. Therefore, in the present invention, micro-cracks which are produced at inner and outer circumference end faces of a glass substrate are eliminated by etching which can take the place of the aforementioned chemical polishing function. Accordingly, it is possible to perform polishing for inner and outer circumference end faces of a glass substrate, without using cerium oxide slurry, which is expensive and has been used in the conventional method, or with a reduced amount of cerium oxide.

Furthermore, in the polishing treatment performed for inner and outer circumference end faces of a glass substrate of the present invention, it is not necessary to perform conventional polishing, wherein cerium oxide slurry is used, and it is possible to perform polishing merely with silicon oxide slurry. Alternatively, it is also possible to reduce the time of polishing treatment, wherein cerium oxide slurry is used, so that the usage of cerium oxide decreases. In this way, the present invention enables a reduction of a polishing cost required for a glass substrate for a magnetic storage medium, and achieves high productivity.

Hereinafter, a method of manufacturing a glass substrate for a magnetic storage medium according to the present invention is concretely explained, while referring to each example of the first embodiment and the second embodiment.

### Examples of First Embodiment

In examples of the first embodiment, a primary lapping step for principal surfaces; a grinding step for an end face of inner circumference and for an end face of outer circumference; an etching step for the inner and outer circumference end faces; a polishing step for the inner circumference end face; a secondary lapping step for the principal surfaces; a tertiary lapping step for the principal surfaces; a polishing step for the end face of the outer circumference; and a polishing step for the principal surfaces, are performed in this order.

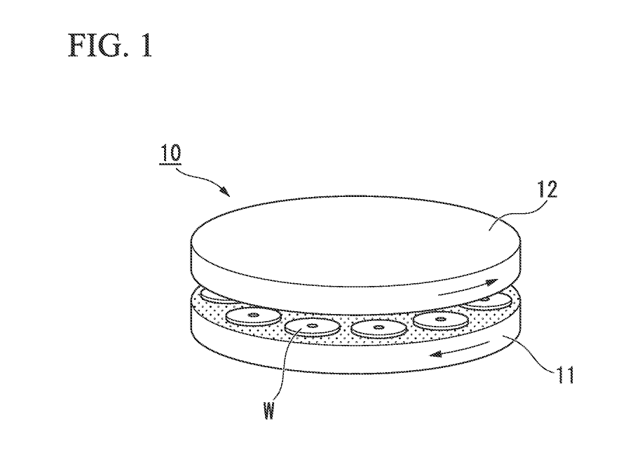

Among the steps, a primary lapping step for principal surfaces is performed such that primary lapping is performed for both primary surfaces of a glass substrate W (a surface which forms finally a recording face of a magnetic recording medium) with a lapping machine 10 as shown in FIG. 1. The lapping machine 10 is equipped with a pair of upper and lower surface plates 11 and 12, and plural glass substrates W are sandwiched between the surface plates 11 and 12, which are rotated in the opposite directions to each other, so that both principal surfaces of the glass substrates W are grinded by a grinding pad provided to the surface plates 11 and 12.

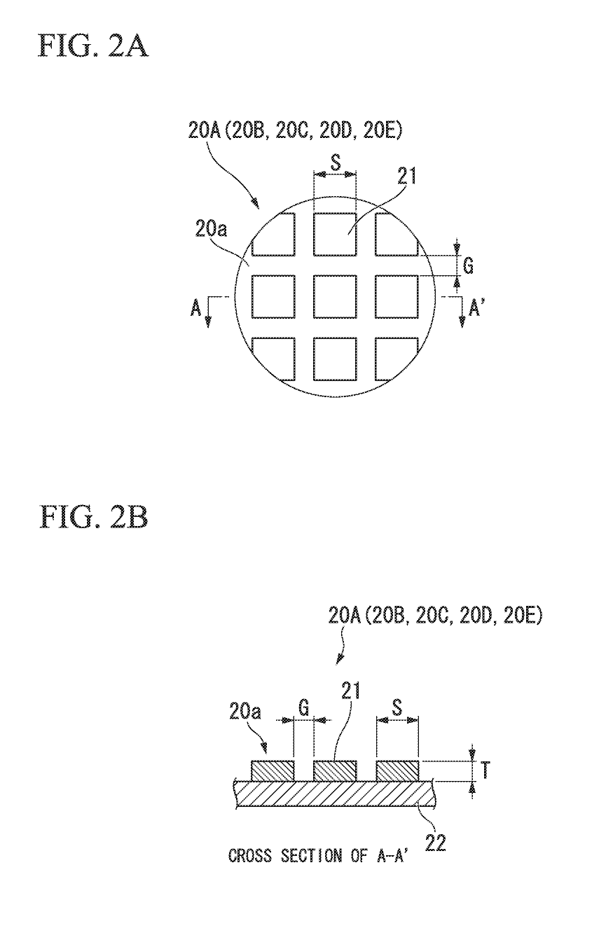

As shown in FIG. 2A and FIG. 2B, the grinding pad used in the primary lapping is a diamond pad 20A to which diamond abrasive grains are fixed by a binder (bond), and plural tile-like extruding peak portions 21, which have even top parts, are provided regularly on a lap surface 20a thereof. The diamond pad 20A is formed such that the peak portions 21 to which the diamond abrasive grains are fixed by the binder are arrayed on the surface of the substrate 22.

The diamond pad 20A used in the primary lapping has preferably a structure such that peak portions 21 are squares, the outside dimension S thereof is 1.5 to 5 mm, height T thereof is 0.2 to 3 mm and distance G between adjacent peak portions 21 is in a range of 0.5 to 3 mm. In the present invention, when the diamond pad 20A satisfies the aforementioned ranges, a cooling liquid, a grinding liquid or the like can be supplied evenly, and grinding waste or the like can be smoothly removed from a space provided between the peak portions 21 of the lap surface 20a.

In addition, it is preferable that the diamond pad 20A used in the primary lapping have diamond abrasive grains having an average particle diameter of 4 μm or more and 12 μm or less, and the amount of the diamond abrasive grains in the peak portion 21 be in a range of 5 to 70% by volume, and more preferably, in a range of 20 to 30% by volume. When the average particle diameter and the amount of diamond abrasive grains are less than said ranges, the cost increases since treatment time is extended. On the other hand, when the average particle diameter and the amount of diamond abrasive grains exceed the ranges, it is difficult to achieve target surface roughness. As a binder used for a diamond pad 20A, for example, polyurethane resins, phenolic resins, melamine resins, acrylic resins and the like can be used.

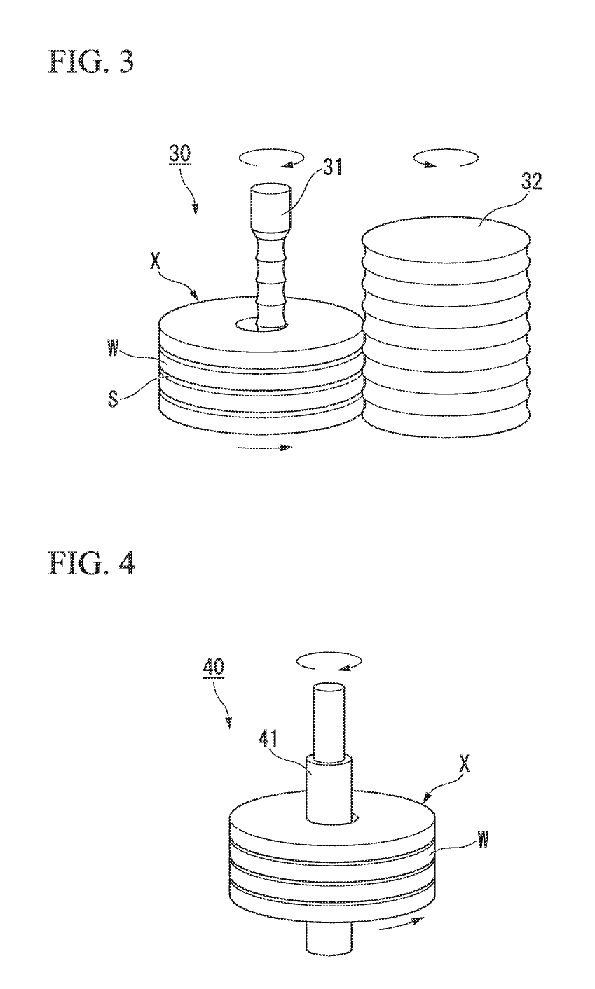

In a grinding step for the inner and outer circumference end faces, grinding is performed for the inner circumference end face of a central aperture of the glass substrate W and for the outer circumference end face of the glass substrate W, with a grinding apparatus 30 as shown in FIG. 3. That is, the grinding apparatus 30 includes an inner circumference grinding wheel 31 and an outer circumference grinding wheel 32, and the apparatus rotates a laminate X, wherein plural glass substrates are laminated via spacers S so that central apertures thereof are accorded, around the axis. While rotating the laminate, each glass substrate W is sandwiched at the radial direction, between the inner circumference grinding wheel 31, which is inserted in the central aperture of the glass substrates W, and the outer circumference grinding wheel 32, which is provided at the outer circumference of the glass substrates W, and the inner circumference grinding wheel 31 and the outer circumference grinding wheel 32 are rotated in the direction which is opposite the rotating direction of the laminate X. Therefore, while the inner circumference grinding wheel 31 grinds the inner circumference end face of each glass substrate W, the outer circumference grinding wheel 32 grinds the outer circumference end face of each glass substrate W.

In addition, the surfaces of the inner circumference grinding wheel 31 and the outer circumference grinding wheel 32 have a wave-like structure, wherein peak portions and valley portions exist alternately over the axial direction. Accordingly, while grinding is performed for the inner circumference end face and the outer circumference end face of each glass substrate W, it is possible to perform chamfer treatment for edge portions (chamfer surfaces) which exist at positions where the inner circumference end face and the outer circumference end face meet the primary surfaces of the glass substrate W.

To the inner circumference grinding wheel 31 and the outer circumference grinding wheel 32, diamond abrasive grains are fixed with a binder. As a binder, metal such as copper, copper alloy, nickel, nickel alloy, cobalt, tungsten carbide and the like can be cited. An average particle diameter of the diamond abrasive grains which are included in the inner circumference grinding wheel 31 and the outer circumference grinding wheel 32 is preferably 4 μm or more and 12 μm or less. Furthermore, it is preferable that the inner circumference grinding wheel 31 and the outer circumference grinding wheel 32 include diamond abrasive grains in a range of 5 to 95% by volume, and more preferably in a range of 20 to 85% by volume. When the average particle diameter and the amount of diamond abrasive grains are less than the ranges, cost increases since treatment time is extended. On the other hand, when the average particle diameter and the amount of diamond abrasive grains exceed the ranges, it is difficult to achieve target surface roughness.

In an etching step for the inner and outer circumference end faces, the glass substrate W is immersed in an etching solution, and etching treatment is performed for the inner and outer circumference end faces of the glass substrate W. Said etching treatment can make up for a chemical polishing function provided by the aforementioned conventional CMP, wherein cerium oxide slurry is used, and can eliminate micro-cracks generated at the inner and outer circumference end faces of the glass substrate W. Here, when chamfering is also performed before the etching, as shown in examples of the first embodiment, it is possible to remove not only micro-cracks generated at the inner and outer circumference end faces, but also micro-cracks generated at faces (chamfer surfaces) at which chamfering was performed.

Specifically, in the etching step for the inner and outer circumferences end faces, although not shown in Figures, a laminate X of glass substrates W, to which chamfering has been performed in the aforementioned grinding step for the inner and outer circumference end faces, is immersed in an etching solution, which is stored in an etching tank, to perform etching treatment for inner and outer circumference end faces of each glass substrate W.

Due to the etching treatment, the etching solution enters in micro-cracks of the glass substrate W, which are generated in the aforementioned grinding step performed for the inner and outer circumference end faces, and end portions of the micro-cracks are etched to form round bottoms. Accordingly, even if stress is applied to the end portions, a condition is maintained wherein the degree of cracks no longer proceeds. Furthermore, micro-cracks having shallow depth are eliminated by the etching. As a result, the glass substrate W from which micro-cracks are eliminated has increased mechanical strength (impact resistance), and therefore, a magnetic recording medium to which such a glass substrate W is applied also has improved impact resistance.

In addition, in the etching step for the inner and outer circumference end faces, it is possible to perform etching of the inner and outer circumference end faces of each glass substrate W, to which chamfer treatment was performed in the aforementioned grinding step for the inner and outer circumference end faces, by immersing each glass substrate W in an etching solution stored in an etching tank.

In this way, etching treatment can be performed by immersing each glass substrate W in an etching solution, but etching is not limited to such an etching wherein immersion is performed. It is also possible to perform etching by a method wherein an etching solution is coated to inner and outer circumference end faces of a glass substrate W, or the like.

As an etching solution, any solution can be used in so far as the solution has etching action with respect to a glass substrate W. For example, a hydrofluoric acid-based etching solution, which includes a hydrofluoric acid (HF), a fluorosilicic acid (H₂SiF₆) or the like as a main component, can be used. Among them, a hydrofluoric acid solution is preferable. Furthermore, by adding inorganic acid such as sulfuric acid, nitric acid and hydrochloric acid to such a hydrofluoric acid-based etching solution, etched degree and etching characteristics can be controlled. Furthermore, as the concentration of the hydrofluoric acid-based etching solution, a concentration can be selected and used which does not chap surfaces of glass substrates obtained by grinding the inner and outer circumference end faces of the glass substrate W and can eliminate micro-cracks generated on the surfaces of the glass substrate W. For example, although concentration is not limited, a hydrofluoric acid-based etching solution having a concentration in a range of 0.01 to 10% by mass can be used.

It is preferable that a temperature of an etching solution be set, for example, in a range of 15 to 65° C., and etching (immersing) time be set, for example, in a range of 0.5 to 30 minutes, although immersing conditions of a glass substrate W are determined depending on, for example, a kind and/or concentration of an etching solution, materials of a glass substrate W or the like. Concretely, immersion conditions wherein immersion is performed for about 15 minutes using an aqueous solution of 0.5% by mass of hydrofluoric acid at a solution temperature of 30° C., or immersion conditions wherein immersion is performed for about 10 minutes using a mixed aqueous solution which includes 1.5% by mass of hydrofluoric acid and 0.5% by mass of sulfuric acid at a solution temperature of 30° C., can be cited. Here, in the etching step for the inner and outer circumference end faces, etching may be performed for all surfaces of a glass substrate W, or etching may be partially performed merely for inner and outer circumference end faces thereof. Furthermore, it is preferable that the glass substrate W be cleaned after etching, to remove any etching solution remaining on the glass substrate W.

In a polishing step for the inner circumference end face, polishing is performed for the inner circumference end face existing at a central aperture of the glass substrate W, with a polishing machine 40 as shown in FIG. 4. That is, the polishing machine 40 is equipped with an inner circumference polishing brush 41, which is inserted in the central aperture of each glass substrate W, and is operated so that said brush goes up and down while rotating in the opposite direction to that of the glass substrate W, when the laminate X is rotated around the axis. At this time, a polishing liquid is dropped to the inner circumference polishing brush 41. The inner circumference end face of each glass substrate W is polished by the inner circumference polishing brush 41, and simultaneously, edge portions (chamfer surfaces) of the inner circumference end face, to which chamfering was performed in the aforementioned grinding step for the inner and outer circumference end faces, are also polished. As a polishing liquid, for example, a polishing liquid can be used wherein abrasive grains of silicon oxide (colloidal silica) or abrasive grains of cerium oxide are dispersed in water to faun slurry.

Speed-up of polishing is not easy due to characteristics thereof, and therefore, longer treatment time is required for polishing as compared with that of grinding. Furthermore, smoothness required for an inner circumference end face (including a chamfer surface) of a glass substrate W is low as compared with smoothness required for principal surfaces of the glass substrate W (Ra: 0.3 to 0.5 nm), and Ry thereof is at a level of 10 μm or less (several μm). Accordingly, adoption of generally used abrasive grains (particle size is less than or equal to 0.3 μm) of silicon oxide (colloidal silica) tends to prolong polishing time due to the too small size thereof, although such time also depends on other polishing conditions. Based on such a reason, average particle diameter of abrasive grains of silicon oxide (colloidal silica) is preferably 0.4 μm or more and 1 μm or less, and more preferably 0.45 μm or more and 0.6 μm or less.

The present invention enables the elimination of micro-cracks generated at the inner circumference end face of the aforementioned glass substrate W by performing etching for the inner circumference end face of the glass substrate W. Therefore, even when polishing is performed with cerium oxide slurry, treatment time can be reduced as compared with conventional cases.

In a secondary lapping step for the principal surfaces, similar to the primary lapping step for the principal surfaces, secondary lapping is performed for both principal surfaces of the glass substrate W with a lapping machine 10 as shown in FIG. 1. That is, plural glass substrates W are sandwiched between a pair of surface plates 11 and 12, which are arranged on upper and lower sides and are rotated in the opposite directions to each other, and both principal surfaces of the glass substrates W are grinded by a grinding pad provided to the surface plates 11 and 12.

The grinding pad used in the secondary lapping is a diamond pad 20B to which diamond abrasive grains are fixed by a binder (bond) similar to the grinding pad 20A shown in FIG. 2A and FIG. 2B. Furthermore, plural tile-like extruding peak portions 21, which have even top parts, are provided regularly on a lap surface 20a thereof. The diamond pad 20B is formed such that the peak portions 21 wherein the diamond abrasive grains are fixed by the binder are arrayed on the surface of the substrate 22.

Here, the diamond pad 20B used in the secondary lapping has preferably a structure such that the peak portions 21 are squares, outside dimension S thereof is 1.5 to 5 mm, height T thereof is 0.2 to 3 mm and distance G between adjacent peak portions 21 is in a range of 0.5 to 3 mm, similar to the diamond pad 20A shown in FIGS. 2A and 2B. In the present invention, when a diamond pad 20B which satisfies the aforementioned ranges is used, a cooling liquid, a grinding liquid or the like can be supplied evenly, and grinding waste or the like can be smoothly removed from a space between the peak portions 21 of the lap surface 20a.

In addition, it is preferable that the diamond pad 20B used in the secondary lapping include diamond abrasive grains having an average particle diameter of 1 μm or more and 5 μm or less, and the amount of diamond abrasive grains in a peak portion 21 be in a range of 5 to 80% by volume, and more preferably, 50 to 70% by volume. When the average particle diameter and the amount of diamond abrasive grains are less than said ranges, cost increases since treatment time is prolonged. On the other hand, when the average particle diameter and the amount of diamond abrasive grains exceed the ranges, it is difficult to achieve target surface roughness. As the binder used for the diamond pad 20B, for example, polyurethane resins, phenolic resins, melamine resins, acrylic resins and the like can be used.

In a tertiary lapping step for the principal surfaces, similar to the primary and the secondary lapping steps performed for the principal surfaces, the tertiary lapping is performed for both principal surfaces of the glass substrate W with a lapping machine 10 as shown in FIG. 1. That is, plural glass substrates W are sandwiched between a pair of the surface plates 11 and 12, which are arranged on upper and lower sides and are rotated in the opposite directions to each other, and both principal surfaces of the glass substrates W are grinded by a grinding pad provided to the surface plates 11 and 12.

The grinding pad used in the tertiary lapping is a diamond pad 20C to which diamond abrasive grains are fixed by a binder (bond), similar to the grinding pad 20A shown in FIG. 2A and FIG. 2B. Furthermore, plural tile-like extruding peak portions 21, which have even top parts, are provided regularly on a lap surface 20a thereof. The diamond pad 20C is formed such that the peak portions 21 wherein the diamond abrasive grains are fixed by the binder are arrayed on the surface of the substrate 22.

Here, the diamond pad 20C used in the tertiary lapping has preferably a structures such that that the peak portions 21 are squares, outside dimension S thereof is 1.5 to 5 mm, height T thereof is 0.2 to 3 mm and distance G between adjacent peak portions 21 is in a range of 0.5 to 3 mm, similar to the diamond pad 20A shown in FIGS. 2A and 2B. In the present invention, when a diamond pad 20C which satisfies the aforementioned ranges is used, a cooling liquid, a grinding liquid or the like can be supplied evenly, and grinding waste or the like can be smoothly removed from a space between the peak portions 21 of the lap surface 20a.

In addition, it is preferable that the diamond pad 20C used in the tertiary lapping include diamond abrasive grains having an average particle diameter of 0.2 μm or more and less than 2 μm, and the amount of diamond abrasive grains included in a peak portion 21 be in a range of 5 to 80% by volume, and more preferably, a range of 50 to 70% by volume. When the average particle diameter and the amount of diamond abrasive grains are less than said ranges, cost increases since treatment time is prolonged. On the other hand, when the average particle diameter and the amount of diamond abrasive grains exceed the ranges, it is difficult to achieve target surface roughness. As the binder used for a diamond pad 20B, for example, polyurethane resins, phenolic resins, melamine resins, acrylic resins and the like can be used.

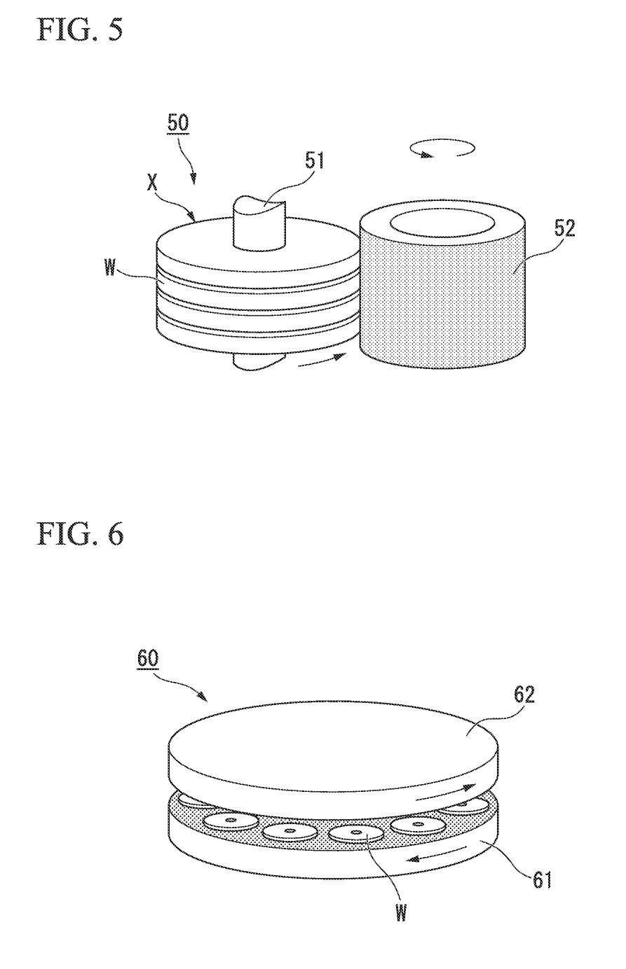

In a polishing step for the outer circumference end face, polishing is performed with respect to the outer circumference end face of the glass substrate W with a polishing machine 50 as shown in FIG. 5. That is, the polishing machine 50 is equipped with a rotating shaft 51 and an outer circumference polishing brush 52, and a laminate X, wherein plural glass substrates W are laminated via spacers S so that central apertures thereof are accorded, is rotated around the axis by the rotating shaft 51 which is inserted in the central aperture of each glass substrate W. The outer circumference polishing brush 52, which is allowed to contact with the outer circumference end face of each glass substrate W, is operated so that the brush goes up and down while rotating in the opposite direction to that of the laminate X. At this time, a polishing liquid is dropped to the outer circumference polishing brush 52. Then, an outer circumference end face of each glass substrate W is polished by the outer circumference polishing brush 52, and simultaneously, edge portions (chamfer surfaces) of the outer circumference end face, to which chamfering was performed in the aforementioned lapping step for the inner and outer circumferences, are also polished. As a polishing liquid, for example, a polishing liquid can be used wherein abrasive grains of silicon oxide (colloidal silica) or abrasive grains of cerium oxide are dispersed in water to form slurry.

Speed-up of polishing is not easy due to characteristics thereof, and therefore longer treatment time is required for polishing as compared with that of grinding. Furthermore, smoothness required for an outer circumference end face (including a chamfer surface) of a glass substrate W is low as compared with smoothness required for principal surfaces of the glass substrate W (Ra: 0.3 to 0.5 nm), and Ry thereof is at a level of 10 μm or less (several μm). Accordingly, adoption of generally used abrasive grains (particle size is less than or equal to 0.3 μm) of silicon oxide (colloidal silica) tends to prolong polishing time due to the too small size thereof, although such time also depends on other polishing conditions. Based on such a reason, average particle diameter of abrasive grains of silicon oxide (colloidal silica) is preferably 0.4 μm or more and 1 μm or less, and more preferably 0.45 μm or more and 0.6 μm or less.

The present invention enables the elimination of micro-cracks which are generated at the outer circumference end face of the aforementioned glass substrate W by performing the aforementioned etching with respect to the outer circumference end face. Therefore, even when polishing is performed with cerium oxide slurry, treatment time can be reduced as compared with conventional cases.

In a polishing step for the principal surfaces, polishing is performed for both principal surfaces of the glass substrate W with a polishing machine 60 as shown in FIG. 6. That is, the polishing machine 60 includes a pair of surface plates 61 and 62, which are arranged on upper and lower sides and rotate in the opposite directions to each other, plural glass substrates W are sandwiched between said surface plates 61 and 62, and both principal surfaces of the glass substrates W are polished by a grinding pad provided to the surface plates 61 and 62.

For example, an abrasive pad to be used for the polishing may be a hard abrasive cloth which is formed with urethane. In addition, polishing liquid is dropped to the glass substrate W when polishing is performed for both principal surfaces of the glass substrate W using the abrasive pad. For example, as a polishing liquid, a liquid can be used wherein abrasive grains of silicon oxide (colloidal silica) are dispersed in water to form slurry.

The glass substrate W, to which lapping, grinding and polishing were performed, is sent to a final cleaning step and an inspection step. The glass substrate W is cleaned in the final cleaning step, for example, with a method such as a chemical cleaning, wherein a detergent (chemical agent) is used in combination with supersonic waves, in order to remove abrasives or the like used in the aforementioned steps. Furthermore, in the inspection step, whether or not scratches and/or strains exist on the surfaces (principal surfaces, end faces and chamfer faces) of the glass substrate W is inspected with, for example, an optical tester wherein laser is used.

### Examples of Second Embodiment

In examples of the second embodiment, a primary lapping step for principal surfaces; a primary grinding step for an end face of inner circumference and an end face of outer circumference: a secondary grinding step for the inner and outer circumference end faces: an etching step for the inner and outer circumference end faces: a polishing step for the inner circumference end face: a secondary lapping step for the principal surfaces: a polishing step for the outer circumference end face: and a polishing step for the principal surfaces, are performed in this order.

In the steps, a primary lapping step for principal surfaces is performed such that primary lapping is performed for both primary surfaces of a glass substrate W (a surface which finally forms a recording face of a magnetic recording medium) with a lapping machine 10 as shown in FIG. 1. That is, the lapping machine 10 is equipped with a pair of upper and lower surface plates 11 and 12, and plural glass substrates W are sandwiched between the surface plates 11 and 12, which are rotated in the opposite directions to each other, so that both principal surfaces of the surface plates are grinded by a grinding pad provided to the surface plates 11 and 12.

The grinding pad used in the primary lapping is a diamond pad 20D to which diamond abrasive grains are fixed by a binder (bond), similar to the diamond pad 20A shown in FIG. 2A and FIG. 2B. Plural tile-like extruding peak portions 21, which have even top parts, are provided regularly on a lap surface 20a thereof. The diamond pad 20D is formed such that the peak portions 21 to which the diamond abrasive grains are fixed by the binder are arrayed on the surface of the substrate 22.

The diamond pad 20D used in the primary lapping has preferably a structure such that the peak portions 21 are squares, outside dimension S thereof is 1.5 to 5 mm, height T thereof is 0.2 to 3 mm and distance G between adjacent peak portions 21 is in a range of 0.5 to 3 mm. In the present invention, when a diamond pad 20D which satisfies the aforementioned ranges is used, a cooling liquid, a grinding liquid or the like can be supplied evenly, and grinding waste or the like can be smoothly removed from a space between the peak portions 21 of the lap surface 20a.

In addition, it is preferable that the diamond pad 20D used in the primary lapping include diamond abrasive grains having an average particle diameter of 3 μm or more and 10 μm or less, and the amount of diamond abrasive grains included in a peak portion 21 be in a range of 5 to 70% by volume, and more preferably, in a range of 20 to 30% by volume. When the average particle diameter and the amount of diamond abrasive grains are less than said ranges, cost increases since treatment time is extended. On the other hand, when the average particle diameter and the amount of diamond abrasive grains exceed the ranges, it is difficult to achieve target surface roughness. As the binder used for the diamond pad 20A, for example, polyurethane resins, phenolic resins, melamine resins, acrylic resins and the like can be used.

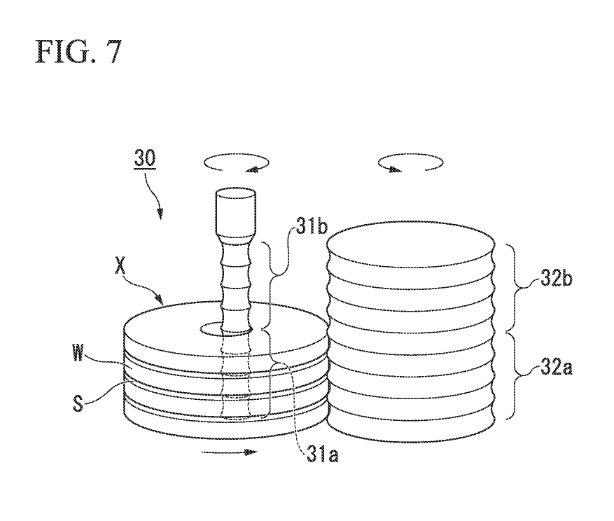

In a grinding step for the inner and outer circumference end faces, primary grinding is performed for the inner circumference end face of a central aperture of the glass substrate W and for the outer circumference end face of the glass substrate W, with a grinding apparatus 30A as shown in FIG. 7. That is, the grinding apparatus 30 includes a first inner circumference grinding wheel 31a and a first outer circumference grinding wheel 32a, and rotates a laminate X, wherein plural glass substrates are laminated via spacers S so that central apertures thereof are accorded, around the axis. Each glass substrate W is sandwiched at the radial direction, between the first inner circumference grinding wheel 31a, which is provided in the central aperture of the glass substrates W, and the first outer circumference grinding wheel 32a, which is provided at the outer circumference of the glass substrates W. The first inner circumference grinding wheel 31a and the first outer circumference grinding wheel 32a are rotated in the direction which is opposite to that of the laminate X, while the laminate is rotated. Therefore, while the inner circumference end face of each glass substrate W is grinded by the first inner circumference grinding wheel 31a, the outer circumference end face of each glass substrate W is grinded by the first outer circumference grinding wheel 32a simultaneously.

In addition, the surfaces of the first inner circumference grinding wheel 31a and the outer circumference grinding wheel 32a have a wave-like structure, wherein peak portions and valley portions exist alternately over the axial direction. Accordingly, while grinding is performed for the inner circumference end face and the outer circumference end face of each glass substrate W, it is also possible to perform chamfering of edge portions (chamfer surfaces) which exist at positions where the inner circumference end face and the outer circumference end face meet the primary surfaces of each glass substrate W.

To the first inner circumference grinding wheel 31a and the first outer circumference grinding wheel 32a, diamond abrasive grains are fixed with a binder. As a binder, metal such as copper, copper alloy, nickel, nickel alloy, cobalt, tungsten carbide and the like can be cited. An average particle diameter of the diamond abrasive grains which are included in the first inner circumference grinding wheel 31a and the first outer circumference grinding wheel 32a is preferably 4 μm or more and 12 μm or less. Furthermore, it is preferable that the first inner circumference grinding wheel 31a and the first outer circumference grinding wheel 32a include diamond abrasive grains in a range of 30 to 95% by volume, and more preferably in a range of 50 to 85% by volume. When the average particle diameter and the amount of the diamond abrasive grains are less than the ranges, cost increases since treatment time is extended. On the other hand, when the average particle diameter and the amount of diamond abrasive grains exceed the ranges, it is difficult to achieve target surface roughness.

In a secondary grinding step for the inner and outer circumference end faces, secondary grinding is performed for the inner circumference end face of a central aperture of the glass substrate W, and for the outer circumference end face of the glass substrate W, with a grinding apparatus 30A as shown in FIG. 7. That is, the grinding apparatus 30A includes a second inner circumference grinding wheel 31b and a second outer circumference grinding wheel 32b, which are arranged following, in an axis direction, the first inner circumference grinding wheel 31a and the first outer circumference grinding wheel 32a, and the apparatus rotates the laminate X, wherein plural glass substrates are laminated via spacers S so that central apertures thereof are accorded, around the axis. Each glass substrate W is sandwiched at the radial direction between the second inner circumference grinding wheel 31b, which is provided in the central aperture of the glass substrates W, and the second outer circumference grinding wheel 32b, which is provided at the outer circumference of the glass substrates W. The second inner circumference grinding wheel 31b and the second outer circumference grinding wheel 32b are rotated in the direction which is opposite to that of the laminate X, while the laminate X is rotated. Therefore, while the inner circumference end face of each glass substrate W is grinded by the second inner circumference grinding wheel 31b, the end face of the outer circumference of each glass substrate W is grinded by the second outer circumference grinding wheel 32b simultaneously. Furthermore, chamfering for edge portions (chamfer surfaces) which exist at positions where the inner circumference end face and the outer circumference end face meet the principal surfaces of each glass substrate W are performed.

Namely, in the primary grinding step and the secondary grinding step for the inner and outer circumference end faces, the primary grinding and the secondary grinding can be performed in succession, since positions of the first inner circumference grinding wheel 31a and the first outer circumference grinding wheel 32a and positions of the second inner circumference grinding wheel 31b and the second outer circumference grinding wheel 32b are switched with respect to the positions of the inner circumference end face and the outer circumference end face of a glass substrate W.

To the second inner circumference grinding wheel 31b and the second outer circumference grinding wheel 32b, diamond abrasive grains are fixed with a binder. As a binder, metal such as copper, copper alloy, nickel, nickel alloy, cobalt, tungsten carbide and the like can be cited. An average particle diameter of diamond abrasive grains, which are included in the second inner circumference grinding wheel 31b and the second outer circumference grinding wheel 32b, is preferably in a range of 4 μm or more and 12 μm or less, and it is preferable that the average particle diameter thereof be smaller than that of the first inner circumference grinding wheel 31a and the first outer circumference grinding wheel 32a. Furthermore, it is preferable that the second inner circumference grinding wheel 31b and the second outer circumference grinding wheel 32b include diamond abrasive grains in a range of 30 to 95% by volume, and more preferably in a range of 50 to 85% by volume. When the average particle diameter and the amount of diamond abrasive grains are less than the ranges, cost increases since treatment time is extended. On the other hand, when the average particle diameter and the amount of diamond abrasive grains exceed the ranges, it is difficult to achieve target surface roughness.

In an etching step for the inner and outer circumference end faces, the glass substrate W is immersed in an etching solution to perform etching for the inner and outer circumference end faces of the glass substrate W. Said etching makes up for a chemical polishing function provided by the aforementioned conventional CMP, wherein cerium oxide slurry is used, and eliminates micro-cracks generated at the inner and outer circumference end faces of the glass substrate W. Here, when chamfering was performed before etching as shown in examples of the first embodiment, it is possible to eliminate not only micro-cracks generated at the inner and outer circumference end faces, but also micro-cracks generated at faces (chamfer surfaces) at which chamfering was performed.

Concretely, in the etching step for the inner and outer circumference end faces, although not shown in Figures, the laminate X of the glass substrates W, to which chamfer treatment has been performed in the aforementioned grinding step for inner and outer circumference end faces, is immersed in an etching solution, which is stored in an etching tank, in order to perform etching for the inner and outer circumference end faces of each glass substrate W.

Due to the etching, the etching solution enters in micro-cracks which were generated at the glass substrate W in the grinding step, and end portions of the micro-cracks are etched to form round bottoms. Accordingly, even if stress is applied at the end portions, a condition is maintained wherein the degree of cracks no longer proceeds. Furthermore, micro-cracks having shallow depth are eliminated by etching. As a result, the glass substrate A from which micro-cracks were eliminated has increased mechanical strength (impact resistance), and therefore, a magnetic recording medium to which the glass substrate W is applied has improved impact resistance.

Although etching can be performed by immersing a glass substrate W in an etching solution as described above, etching is not limited to such an etching treatment wherein immersion is performed. It is also possible to perform etching by a method, wherein an etching solution is coated to inner and outer circumference end faces of a glass substrate W, or the like.

As the etching solution, any solution can be used in so far as the solution has etching action with respect to a glass substrate W. For example, a hydrofluoric acid-based etching solution, which includes a hydrofluoric acid (HF), a fluorosilicic acid (H₂SiF₆) or the like as a main component, can be used. Among them, a hydrofluoric acid solution is preferable. Furthermore, by adding inorganic acid such as sulfuric acid, nitric acid and hydrochloric acid to such a hydrofluoric acid-based solution, it is possible to control the etched degree and etching characteristics. Furthermore, the concentration of a hydrofluoric acid-based etching solution is not limited, and can be selected from concentrations, which neither dissolve excessively nor chap the surfaces of the glass substrate which was obtained after grinding of the inner and outer circumference end faces of the glass substrate W, and which can eliminate micro-cracks generated on the surfaces of the glass substrate W. For example, the hydrofluoric acid-based etching solution can be used in a concentration range of 0.01 to 10% by mass.

Although immersing conditions of a glass substrate W depend on, for example, a kind and/or concentration of an etching solution, materials of a glass substrate W or the like, it is preferable that a temperature of an etching solution be set, for example, in a range of 15 to 65° C., and etching (immersing) time be set, for example, in a range of 0.5 to 30 minutes. Concretely, immersion conditions, wherein immersion is performed for about 15 minutes using an aqueous solution of 0.5% by mass of hydrofluoric acid at a solution temperature of 30° C., or immersion conditions, wherein immersion is performed for about 10 minutes using a mixed aqueous solution which includes 1.5% by mass of hydrofluoric acid and 0.5% by mass of sulfuric acid at a solution temperature of 30° C., can be cited. Here, in the etching step for the inner and outer circumference end faces, etching may be performed for all surfaces of the glass substrate W, or etching may be partially performed merely for the end faces of inner and outer circumferences thereof. Furthermore, after etching, it is preferable that the glass substrate W be cleaned to remove any etching solution remaining on the glass substrate W.

In a polishing step performed for the inner circumference end face, polishing is performed for an inner circumference end face of a central aperture of the glass substrate W by a polishing machine 40 as shown in FIG. 4. That is, the polishing machine 40 is equipped with an inner circumference polishing brush 41. The inner circumference polishing brush 41 is inserted in the central aperture of each glass substrate W, and is operated so that said brush goes up and down while rotating in the opposite direction to that of the glass substrate W, when the laminate X rotates around the axis. At this time, a polishing liquid is dropped to the inner circumference polishing brush 41. Then, the inner circumference end face of each glass substrate W is polished by the inner circumference polishing brush 41. Simultaneously, edge portions (chamfer surfaces) of the inner circumference end face, to which chamfering was performed in the aforementioned grinding step for inner and outer circumference end faces, are also polished. As a polishing liquid, for example, a polishing liquid can be used wherein abrasive grains of silicon oxide (colloidal silica) or abrasive grains of cerium oxide are dispersed in water to form slurry.

Speed-up of polishing is not easy due to characteristics thereof, and therefore longer treatment time is required for polishing as compared with that of grinding. Furthermore, smoothness required for an inner circumference end face (including a chamfer surface) of a glass substrate W is low as compared with smoothness required for principal surfaces of the glass substrate W (Ra: 0.3 to 0.5 nm), and Ry required for such an end face is at a level of 10 μm or less (several μm). Accordingly, adoption of generally used abrasive grains (particle size is less than or equal to 0.3 μm) of silicon oxide (colloidal silica) tends to prolong polishing time due to the too small size thereof, although such time also depends on other polishing conditions. Based on such a reason, average particle diameter of silicon oxide (colloidal silica) abrasive grains is preferably 0.4 μm or more and 1 μm or less, and more preferably 0.45 μm or more and 0.6 μm or less.

Furthermore, the present invention enables to eliminate micro-cracks generated at the inner circumference end face of the glass substrate W by performing etching with respect to the inner circumference end face of the glass substrate W. Therefore, even when polishing is performed using cerium oxide slurry, treatment time can be reduced as compared with conventional cases.

In a secondary lapping step for the principal surfaces, similar to the primary lapping step for the principal surfaces, secondary lapping is performed for both principal surfaces of the glass substrate W with a lapping machine 10 as shown in FIG. 1. That is, plural glass substrates W are sandwiched between a pair of surface plates 11 and 12, which are arranged on upper and lower sides and are rotated in the opposite directions to each other, and both principal surfaces of the glass substrates W are grinded by a grinding pad provided to the surface plates 11 and 12.

The grinding pad used in the secondary lapping step is a diamond pad 20E to which diamond abrasive grains are fixed by a binder (bond) similar to the grinding pad 20A shown in FIG. 2A and FIG. 2B. Furthermore, plural tile-like extruding peak portions 21, which have even top parts, are provided regularly on a lap surface 20a thereof. The diamond pad 20E is formed such that the peak portions 21 wherein the diamond abrasive grains are fixed by the binder are arrayed on the surface of the substrate 22.

Here, as the diamond pad 20E used in the secondary lapping, it is preferable that the peak portions 21 be squares, the outside dimension S thereof be 1.5 to 5 mm, height T thereof be 0.2 to 3 mm and distance G between adjacent peak portions 21 be in a range of 0.5 to 3 mm, similar to the diamond pad 20A shown in FIGS. 2A and 2B. In the present invention, when a diamond pad 20B which satisfies the aforementioned ranges is used, a cooling liquid, a grinding liquid or the like can be supplied evenly, and grinding waste or the like can be smoothly removed from a space between the peak portions 21 of the lap surface 20a.

In addition, it is preferable that the diamond pad 20E used in the secondary lapping have diamond abrasive grains having an average particle diameter of 0.2 μm or more and less than 2 μm, and the amount of diamond abrasive grains in a peak portion 21 be in a range of 5 to 80% by volume, and more preferably, in a range of 50 to 70% by volume. When the average particle diameter and the amount of diamond abrasive grains are less than said ranges, cost increases since treatment time is extended. On the other hand, when the average particle diameter and the amount of diamond abrasive grains exceed the ranges, it is difficult to achieve target surface roughness. As the binder used for a diamond pad 20E, for example, polyurethane resins, phenolic resins, melamine resins, acrylic resins and the like can be used.

In a polishing step for the outer circumference end face, polishing is performed with respect to an outer circumference end face of the glass substrate W, with a polishing machine 50 as shown in FIG. 5. That is, the polishing machine 50 is equipped with a rotating shaft 51 and an outer circumference polishing brush 52, and the laminate X, wherein plural glass substrates W are laminated via spacers S so that central apertures thereof are accorded, is rotated around the axis by the rotating shaft 51 which is inserted in the central aperture of each glass substrate W. Said brush 52, which contacts with the outer circumference end face of each glass substrate W, is operated so that the brush goes up and down while rotating in the opposite direction to that of the laminate X. At this time, a polishing liquid is dropped to the outer circumference polishing brush 52. Then, an outer circumference end face of each glass substrate W is polished by the outer circumference polishing brush 52. Simultaneously, edge portions (chamfer surfaces) of the outer circumference end face, to which the chamfering was performed in the aforementioned lapping step for the inner and outer circumferences, are also polished. As a polishing liquid, for example, a polishing liquid can be used wherein abrasive grains of silicon oxide (colloidal silica) or abrasive grains of cerium oxide are dispersed in water to form slurry.

Speed-up of polishing is not easy due to characteristics thereof, and therefore longer treatment time is required for polishing as compared with that of grinding. Furthermore, smoothness required for an outer circumference end face (including a chamfer surface) of a glass substrate W is low as compared with smoothness required for principal surfaces of the glass substrate W (Ra: 0.3 to 0.5 nm), and Ry required by the polishing is at a level of 10 μm or less (several μm). Accordingly, adoption of generally used abrasive grains (particle size is less than or equal to 0.3 μm) of silicon oxide (colloidal silica) tends to prolong polishing time due to the too small size thereof, although such time also depends on other polishing conditions. Based on such a reason, average particle diameter of abrasive grains of silicon oxide (colloidal silica) is preferably 0.4 μm or more and 1 μm or less, and more preferably 0.45 μm or more and 0.6 μm or less.

Furthermore, the present invention enables to eliminate micro-cracks, which were generated at the outer circumference end face of the aforementioned glass substrate W, by performing etching with respect to the outer circumference end face. Therefore, even when polishing is performed with cerium oxide slurry, treatment time can be reduced as compared with conventional cases.

In a polishing step for the principal surfaces, polishing is performed for both principal surfaces of the glass substrate W with a polishing machine 60 as shown in FIG. 6. That is, the polishing machine 60 includes a pair of surface plates 61 and 62, which are arranged on upper and lower sides and are rotated in the opposite directions to each other, plural glass substrates W are sandwiched between said surface plates 61 and 62, and both principal surfaces of the glass substrates W are polished by a grinding pad provided to the surface plates 61 and 62.

For example, a polishing pad to be used for a polishing may be a hard abrasive cloth which is formed with urethane. In addition, a polishing liquid is dropped to the glass substrate W, when polishing is performed for both principal surfaces of the glass substrate W by the polishing pad. For example, as a polishing liquid, a liquid can be used wherein abrasive grains of silicon oxide (colloidal silica) are dispersed in water to form slurry.

The glass substrate W, to which lapping, grinding and polishing were performed as described above, is sent to a final cleaning step and an inspection step. Then, the glass substrate W is cleaned in the final cleaning step with a method such as a chemical cleaning, wherein a detergent (chemical agent) is used in combination with supersonic waves, to remove abrasives or the like used in the aforementioned steps. Furthermore, in the inspection step, whether or not scratches and/or strains exist on the surfaces (principal surfaces, end faces and chamfer faces) of the glass substrate W are inspected with, for example, an optical tester wherein laser is used.

In the present invention, commercial liquids can be used as a grinding liquid, which are used for each lapping and grinding of the first and second embodiments. When a grinding liquid is classified roughly, there are an aqueous grinding liquid and an oil-based grinding liquid. An aqueous grinding liquid is a liquid which includes purified water, an appropriate amount of alcohol, a viscosity modifier such as polyethylene glycol and amine, a surfactant, and the like. On the other hand, an oil-based grinding liquid is a liquid to which oil, an appropriate amount of stearic acid as an extreme pressure additive, and the like are added. As a commercial liquid, for example, aqueous grinding solutions such as Sabrelube 9016 (manufactured by Chemetall Corporation) and Coolant D3 (manufactured by Neos Company limited) can be used.

Here, in the present invention, a polishing aid and an anticorrosion agent can be included in a grinding liquid, which is used for each lapping and grinding of the first and second embodiments, and in a polishing liquid, which is used for the polishing of the first and second embodiments.

Specifically, a polishing aid comprises at least an organic polymer which includes a sulfonic acid group or a carboxylic acid group. Among them, an organic polymer, which at least includes sodium sulfonate or sodium carboxylate and has an average molecular weight of 4,000 to 10,000, is preferably used. Due to the aid, it is possible to achieve a still more smooth surface (principal surfaces, end faces and chamfer faces) of a glass substrate W.

Examples of the organic polymer including sodium sulfonate or sodium carboxylate include: Geropon SC/213 (product name, manufactured by Rhodia), Geropon T/36 (product name, manufactured by Rhodia), Geropon TA/10 (product name, manufactured by Rhodia), Geropon TA/72 (product name, manufactured by Rhodia), New Calgen WG-5 (product name, manufactured by Takemoto Oil & Fat Co., Ltd.), Agrisol G-200 (product name, manufactured by Kao Corporation), Demol EP powder (product name, manufactured by Kao Corporation), Demol RNL (product name, manufactured by Kao Corporation), Isoban 600-SF35 (product name, manufactured by Kuraray Co., Ltd.), Polystar OM (product name, manufactured by NOF Corporation), Sokalan CP9 (product name, manufactured by BASF Japan Ltd.), Sokalan PA-15 (product name, manufactured by BASF Japan Ltd.), Toxanon GR-31A (product name, manufactured by Sanyo Chemical Industries, Ltd.), Solpol 7248 (product name, manufactured by Toho Chemical Industry Co., Ltd.), Sharoll AN-103P (product name, manufactured by Dai-Ichi Kogyo Seiyaku Co., Ltd.), Aron T-40 (product name, manufactured by Toagosei Co., Ltd.), Panakayaku CP (product name, manufactured by Nippon Kayaku Co., Ltd.) and Disrol H12C (product name, manufactured by Nippon Nyukazai Co., Ltd.). Among them, Demol RNL (product name, manufactured by Kao Corporation) and Polystar OM (product name, manufactured by NOF Corporation) are particularly preferable as a polishing aid.

Furthermore, a magnetic recording medium, which is manufactured with the glass substrate W, generally includes a corrosive material such as Co, Ni and Fe in a magnetic layer thereof. Accordingly, by adding an anticorrosive to a gridding liquid and/or a polishing liquid, it is possible to prevent corrosion of the magnetic layer and obtain a magnetic recording medium which is excellent in read-write characteristics.

As the anticorrosive, it is preferable that benzotriazole and derivatives thereof be used. Examples of the derivatives of benzotriazole include benzotriazoles, wherein one of, or two or more of hydrogen atoms of benzotriazole is substituted with, for example, a carboxyl group, a methyl group, an amino group, a hydroxyl group or the like. Examples of the derivatives of benzotriazole further include 4-carboxyl benzotriazole and salts thereof, 7-carboxyl benzotriazole and salts thereof, benzotriazole butyl ester, 1-hydroxy methyl benzotriazole and 1-hydroxy benzotriazole. The amount of an anticorrosive is preferably 1% by mass or less, and more preferably 0.001 to 0.1% by mass, based on the total amount of diamond slurry.

Here, the present invention is not necessary to be limited to the examples described in the aforementioned embodiments, and various modifications can be made without departing from the scope of the present invention.

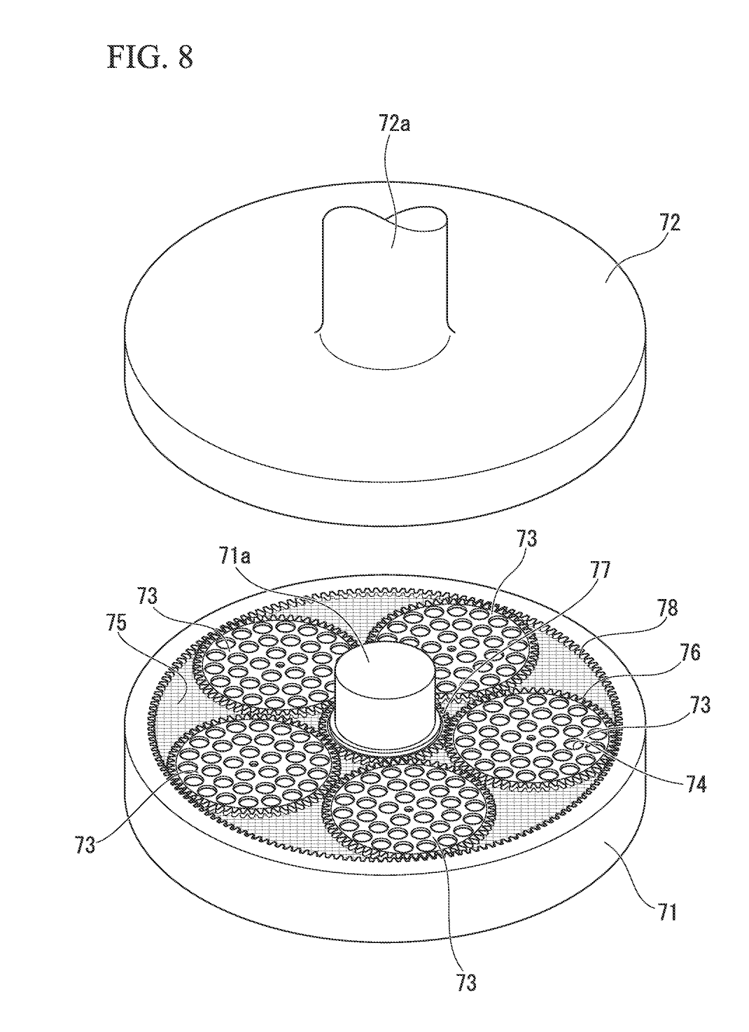

For example, in a lapping machine or a polishing machine, which are usable in each of lapping steps and each polishing step for the first embodiment and the second embodiment, a pair of lower and upper surface plates 71 and 72 and plural carriers 7 may be provided as shown in FIG. 8. The carriers are set on one surface of the lower surface plate 71, wherein said surface faces toward the upper surface plate 72. Plural openings 74 are provided to each carrier 73 (in the present embodiment, 35 openings exist) so that glass substrates (not shown) are set in the openings, and both surfaces of the set glass substrates are grinded by a grinding pad, or polished by a polishing pad, which are provided to the upper and lower surface plates 71 and 72.

Specifically, by driving a rotating motor (not shown) to rotate rotation shafts 71a and 72a which are provided at the center of each surface plate, the upper and lower surface plates 71 and 72 rotate in the opposite directions to each other, while axes thereof are accorded to each other. Furthermore, on the surface of the lower surface plates 71, which faces toward the upper surface plate 72, a recessed portion 75 is provide so that plural carriers 73 are provided in the recessed portion (in the present embodiment, five carriers are provided).

The plural carriers 73 are carriers wherein, for example, a reinforced epoxy resin or the like to which an aramid fiber or a glass fiber has been mixed is formed to disk-like shape

Furthermore, the plural carriers 73 are arranged side by side so that they exist around the rotating shaft 71a and in the recessed portion 75. A planetary gear part 76 is provided around over the outer periphery of each carrier 73. On the other hand, a sun gear part 77 is provided at an inner circumference portion of the recessed portion 75, and a fixed gear part 78 is provided at an outer circumference portion of the recessed portion 75. The sun gear part 77 rotates according to the rotating shaft 71a while being engaged with the planetary gear part 76 of each carrier 73, and the fixed gear 78 is engaged with the planetary gear part 76 of each carrier.

Due to the structure, the plural carriers 73 make so-called planetary motion, wherein, when the sun gear part 77 rotates according to the rotating shaft 71a, by engagement between the sun gear part 77, the fixed gear part 78 and the planetary gear part 76, the carriers move in the recessed portion 75 such that they rotate (rotation) around each center axis thereof to the direction which is opposite to that of the rotation shaft 71a, while they rotate (revolution) around the rotating shaft 71a to the direction similar to that of the rotating shaft 71a.

Accordingly, when the aforementioned structure is adopted for a lapping machine and a polishing machine, which are used in each lapping step and/or polishing step for the first embodiment and the second embodiment, it is possible to polish and/or grind both principal surfaces of the plural glass substrates, which exist in the openings 75 of each carrier 73 and make planetary motion, with a grinding pad or a polishing pad provided to the upper and lower surface plates 71 and 72. Furthermore, when such a structure is used, it is possible to perform grinding and polishing of the glass substrates rapidly and with high accuracy.

### EXAMPLE

Hereinafter, effects of the present invention are shown using examples. It should be understood that the present invention is not limited to the examples shown below, and modifications can be performed suitably without departing from the scope of the present invention.

### Example 1

In Example 1, glass substrates having an outside diameter of 48 mm, a central aperture of 12 mm, and the thickness of 0.560 mm (manufactured by Ohara Corporation, TS-10SX) were used.

With respect to the glass substrates, a primary lapping step for principal surfaces, a grinding step for inner and outer circumference end faces, an etching step for the inner and outer circumference end faces, a polishing step for the inner circumference end face, a secondary lapping step for the principal surfaces, a tertiary lapping step for the principal surfaces, a polishing step for the outer circumference end face, and a polishing step for the principal surfaces, were performed in this order.

Concretely, a lapping machine which was equipped with a pair of upper and lower surface plates was used in the primary lapping step for principal surfaces, and both primary surfaces of the glass substrates were grinded by a grinding pad provided to the surface plates while the glass substrates were sandwiched between the surface plates which were rotated in the opposite directions to each other. As the grinding pad used in the primary lapping step, a diamond pad (Trizact (trade name), manufactured by Sumitomo 3M limited) was used. The diamond pad comprised comprises square peak portions, wherein outside dimension thereof was 2.6 mm, height thereof was 2 mm, distance between adjacent peak portions was 1 mm, diamond abrasive grains included therein had an average particle diameter of 9 μm the amount of the diamond abrasive grains within the peak portions was about 20% by volume, and an acrylic resin was included as a binder. As a lapping machine, a 4-way type double side lapping machine (16B type, manufactured by Hamai corporation) was used such that grinding was performed for 15 minutes under the conditions that a revolution speed of the surface plates was 25 rpm and processing pressure was 120 g/cm². A solution wherein a Coolant D3 (manufactured by Neos Company limited) was diluted ten-fold with water was used, and a grinding amount per one surface of a glass substrate was set to about 100 μm.

In a grinding step for the inner and outer circumference end faces, grinding was performed such that a laminate, wherein the plural glass substrates were laminated via spacers so that central apertures thereof were accorded, was rotated around the axis, and a grinding apparatus, which included an inner circumference grinding wheel and an outer circumference grinding wheel, was used as follows. Each glass substrate was sandwiched at the radial direction between the inner circumference grinding wheel, which was provided in the central aperture of the glass substrates, and the outer circumference grinding wheel, which was provided at the outer circumference of the glass substrates. The inner circumference grinding wheel and the outer circumference grinding wheel were rotated in the direction which was opposite to the rotating direction of the laminate, so that the inner circumference grinding wheel grinds the inner circumference end faces of each glass substrate, and the outer circumference grinding wheel grinds the outer circumference end face of each glass substrate. As the inner circumference grinding wheel and the outer circumference grinding wheel, a wheel which included 80% by volume of diamond abrasive grains having an average particle diameter of 10 μm, and included nickel alloy as a binder was used. Furthermore, grinding was performed for 30 minutes such that a revolution speed of the inner circumference grinding wheel was set to 1200 rpm and that a revolution speed of the outer circumference grinding wheel was set to 600 rpm.

In an etching step for inner and outer circumference end faces, the glass substrates were immersed in an etching solution, and etching treatment was performed for the inner and outer circumference end faces of the glass substrates. A mixed aqueous solution having a concentration, wherein 1.5% by volume of a hydrofluoric acid and 0.5% by volume of sulfuric acid had been included, was used as the etching solution, a temperature of the solution was set to 30° C., and immersing time was set to 10 minutes. Etching was performed such that merely inner and outer circumference end faces of each glass substrate were allowed to be contacted with the etching solution, while 25 sheets of the glass substrates were laminated via spacers. Then, after the etching, the glass substrates were cleaned with purified water.

In a polishing step for the inner circumference end face, a polishing was performed for the inner circumference end face of a central aperture of each glass substrate by a polishing machine equipped with an inner circumference polishing brush. While the laminate was rotated around the axis and a polishing liquid was dropped to the inner circumference polishing brush, the inner circumference polishing brush, which was inserted in the central aperture of each glass substrate, was operated so that said brush went up and down while the brush rotated in the opposite direction to that of the glass substrate. In this time, a nylon brush was used as the inner circumference polishing brush, and silicon oxide slurry was used as a polishing liquid, wherein a silica abrasive solution including 40% by mass of solid content (Compol, manufactured by Fujimi Incorporated, average particle diameter: 0.5 μm) was added to water to be 1% by mass of silica content. Then, polishing was performed for 10 minutes under the condition that a revolution speed of the inner circumference polishing brush was 300 rpm.

In a secondary lapping step for the principal surfaces, grinding was performed with a lapping machine having a pair of surface plates, which were arranged on upper and lower sides and rotated in the opposite directions to each other, and plural glass substrates were sandwiched between the surface plates, and both principal surfaces of the glass substrates were grinded by a grinding pad provided to the surface plates. As the grinding pad used in the secondary lapping step, a diamond pad (Trizact (trade name), manufactured by Sumitomo 3M limited) was used. The diamond pad comprised square peak portions, wherein outside dimension thereof was 2.6 mm, height thereof was 2 mm and distance between adjacent peak portions was 1 mm, diamond abrasive grains included therein had an average particle diameter of 3 μm, the amount of the diamond abrasive grains within the peak portions was about 50% by volume, and an acrylic resin was included as a binder. As a lapping machine, a 4-way type double side lapping machine (16B type, manufactured by Hamai corporation) was used such that grinding was performed for 10 minutes under the conditions that a revolution speed of the surface plates was 25 rpm and processing pressure was 120 g/cm². A solution wherein a COOLANT D3 (manufactured by Neos Company limited) was diluted ten-fold with water was used as a grinding liquid, and a grinding amount per one surface of a glass substrate was set to about 30 μm.

In a tertiary lapping step, grinding was performed with a lapping machine having a pair of surface plates, which were arranged on upper and lower sides and rotated in the opposite directions to each other, such that plural glass substrates were sandwiched between the surface plates, and both principal surfaces of the glass substrates were grinded by a grinding pad provided to the surface plates. As the grinding pad used in the tertiary lapping step, a diamond pad (Trizact (trade name), manufactured by Sumitomo 3M limited) was used. The diamond pad comprised square peak portions, wherein outside dimension thereof was 2.6 mm, height thereof was 2 mm, distance between adjacent peak portions was 1 mm, diamond abrasive grains included therein had an average particle diameter of 0.5 μm, the amount of the diamond abrasive grains within the peak portions was about 60% by volume, and an acrylic resin was included as a binder. As a lapping machine, a 4-way type double side lapping machine (16B type, manufactured by Hamai corporation) was used such that grinding was performed for 10 minutes under the conditions that a revolution speed of the surface plates was 25 rpm, and treatment pressure was 120 g/cm². A solution wherein a COOLANT D3 (manufactured by Neos Company limited) was diluted ten-fold with water was used as a grinding liquid, and a grinding amount per one surface of a glass substrate was set to about 10 μm.

In a polishing step for the outer circumference end face, a polishing was performed for the outer circumference end face of each glass substrate by a polishing machine equipped with an outer circumference polishing brush, while a polishing liquid was dropped to the outer circumference polishing brush. A laminate, wherein the plural glass substrates were laminated via spacers so that central apertures thereof were accorded, was rotated around the axis by a rotating shaft which was inserted in the central aperture of each glass substrate, while the outer circumference polishing brush, which was allowed to contact with the outer circumference end face of each glass substrate, was operated so that the brush went up and down and rotated in the opposite direction to that of the laminate. A nylon brush was used as the outer circumference polishing brush, and silicon oxide slurry was used as the polishing liquid, wherein a silica abrasive solution including 40% by mass of solid content (Compol manufactured by Fujimi Incorporated, average particle diameter: 0.5 μm) was added to water to be 1% by mass of silica content. Polishing was performed for 10 minutes under condition that a revolution speed of the inner circumference polishing brush was 300 rpm.

In a polishing step for the principal surfaces, polishing was performed with a polishing machine having a pair of surface plates which were arranged on upper and lower sides and rotated in the opposite directions to each other. Plural glass substrates were sandwiched between the surface plates, and both principal surfaces of the glass substrates were polished by a polishing pad provided to the surface plates, while a polishing liquid was dropped to the glass substrate. As the polishing pad used in the polishing, a suede type pad (manufactured by Filwel Co., Ltd.) was used, and as the polishing liquid, polishing slurry was used wherein a silica abrasive solution including 40% by mass of solid content (Compol, manufactured by Fujimi Incorporated, average particle diameter: 0.08 μm) was added to water to be 0.5% by mass of silica content. As a polishing machine, a 4-way type double side lapping machine (16B type, manufactured by Hamai corporation) was used such that polishing was performed for 30 minutes under the conditions that a revolution speed of the surface plates was 25 rpm and processing pressure was 110 g/cm², while the polishing liquid was applied at a rate of 7 litter/minute. A polishing amount per one surface of a glass substrate was set to about 2 μm.

Then, chemical cleaning, wherein an anionic surfactant was used in combination with supersonic waves, and cleaning with water were performed for the obtained glass substrates to obtain glass substrates for a magnetic recording medium of Example 1.

### Example 2

In Example 2, a tertiary lapping step performed in Example 1 was omitted, and two steps of a primary and a secondary lapping steps for principal surfaces were performed. As a grinding pad used in the primary lapping, a diamond pad (Trizact (trade name), manufactured by Sumitomo 3M limited) was used. The diamond pad included square peak portions, wherein the outside dimension thereof was 2.6 mm, height thereof was 2 mm, distance between adjacent peak portions was 1 mm, diamond abrasive grains included therein had an average particle diameter of 4 μm, the amount of the diamond abrasive grains within the peak portions was about 50% by volume, and an acrylic resin was included as a binder. As a lapping machine, a 4-way type double side lapping machine (16B type, manufactured by Hamai corporation) was used such that grinding was performed for 10 minutes under the conditions that a revolution speed of the surface plates was 25 rpm and processing pressure was 120 g/cm². A solution wherein a Coolant D3 (manufactured by Neos Company limited) was diluted ten-fold with water was used as a grinding liquid, and a grinding amount per one surface of a glass substrate was set to about 30 μm. Furthermore, as a grinding step, a primary grinding step and a secondary grinding step were performed in succession. In the primary grinding step for the inner and outer circumference end faces, as a first inner circumference grinding wheel and a first outer circumference grinding wheel, wheels which included 80% by volume of diamond abrasive grains having an average particle diameter of 10 μm, and included nickel alloy as a binder was used. On the other hand, in the secondary grinding step for the inner and outer circumference end faces, as a second circumference grinding wheel and a second outer circumference grinding wheel, wheels which included 80% by volume of diamond abrasive grains having an average particle diameter of 5 μm, and included nickel alloy as a binder was used. Other than the aforementioned conditions, glass substrates for a magnetic recording medium were manufactured similar to the method of Example 1.

### Comparative Example 1

In Comparative Example 1, glass substrates for a magnetic recording medium were manufactured similar to the method of Example 1, except that the etching step for inner and outer circumference end faces of Example 1 was not performed.

### Comparative Example 2

In Comparative Example 2, glass substrates for a magnetic recording medium were manufactured similar to the method of Example 1, except that the etching step for the inner and outer circumference end faces of Example 1 was not performed, and ceria slurry was used in the polishing step for the inner circumference end face and that polishing step for the outer circumference end face as a polishing liquid. The ceria slurry was prepared such that a ceria abrasive solution including 12% by mass of solid content (SHOROX, manufactured by Showa Denki K.K., average particle diameter: 0.5 μm) was added to water to be 1% by mass of ceria content.

### Comparative Example 3

In Comparative Example 3, glass substrates for a magnetic recording medium were manufactured similar to the method of Example 2, except that the etching step for inner and outer circumference end faces of Example 2 was not performed.

### Comparative Example 4

In Comparative Example 4, glass substrates for a magnetic recording medium were manufactured similar to the method of Example 2, except that the etching step for the inner and outer circumference end faces of Example 2 was not performed, and ceria slurry was used in the polishing step for the inner outer circumference end face and the polishing steps for the outer circumference end face as a polishing liquid. The ceria slurry was prepared such that a ceria abrasive solution including 12% by mass of solid content (SHOROX, manufactured by Showa Denki K.K., average particle diameter: 0.5 μm) was added to water to be 1% by mass of ceria content.

Subsequently, impact resistant was evaluated for glass substrates for a magnetic storage medium, which were obtained in Examples 1 and 2 and Comparative Examples 1 to 4. Evaluation of impact resistant was performed such that, after chucking of each glass substrate for a magnetic storage medium to a spindle of a motor, each substrate was rotated while rapid acceleration and rapid deceleration thereof were repeated in a range of 0 to 18000 rpm, and a breakage rate of glass substrates was determined. As a result, a breakage rate of glass substrates of Example 1 was 5%, a breakage rate of glass substrates of Example 2 was 6%, a breakage rate of glass substrates of Comparative Example 1 was 25%, a breakage rate of glass substrates of Comparative Example 2 was 8%, a breakage rate of glass substrates of Comparative Example 3 was 31%, and a breakage rate of glass substrates of Comparative Example 4 was 9%.

### BRIEF DESCRIPTION OF THE REFERENCE SYMBOLS

10 Lapping machine
11, 12 Surface plate
20A, 20B Diamond pad
20a Lap surface
21 Peak portion
22 Substrate
30 Grinding apparatus
31 Inner circumference grinding wheel
32 Outer circumference grinding wheel
31a Primary inner circumference grinding wheel
32a Primary outer circumference grinding wheel
31b Secondary inner circumference grinding wheel
32b Primary outer circumference grinding wheel
40 Polishing machine
41 Internal circumference polishing brush
50 Polishing machine
51 Rotating shaft
52 Outer periphery polishing brush
60 Polishing machine
61, 62 Surface plate
71 Lower surface plate
72 Upper surface plate
73 Carrier
74 Apertures
75 Valley portion
76 Planetary gears part
77 Sun gears part
78 Fixed gear part
W Glass substrate
X Laminate
S Spacer

1. A method of manufacturing a glass substrate for a magnetic recording medium, wherein inner and outer circumference end faces of a disk-like glass substrate having a central aperture are at least treated by:
a step of grinding,
a step of etching, and
a step of polishing, wherein
the steps are performed in this order.

2. The method of manufacturing a glass substrate for a magnetic recording medium according to claim 1, wherein silicon oxide is used as an abrasive in the polishing.

3. The method of manufacturing a glass substrate for a magnetic recording medium according to claim 1, wherein an average particle diameter of the silicon oxide is more than or equal to 0.4 μm and less than or equal to 1 μm.

4. The method of manufacturing a glass substrate for a magnetic recording medium according to claim 1, wherein a hydrofluoric acid is used in the etching.

5. The method of manufacturing a glass substrate for a magnetic recording medium according to claim 1, wherein cerium oxide is not used as an abrasive in the polishing.
